(19) United States
(12) Patent Application Publication
(10) Pub. No.: US 2013/0042933 A1
(43) Pub. Date: Feb. 21, 2013

(54) METHODS AND APPARATUS TO DETERMINE A POSITION OF A VALVE

(71) Applicant: Ronald D. Harper, JR., Georgetown, IN (US)

(72) Inventor: Ronald D. Harper, JR., Georgetown, IN (US)

(21) Appl. No.: 13/588,892

(22) Filed: Aug. 17, 2012

Related U.S. Application Data
(60) Provisional application No. 61/525,265, filed on Aug. 19, 2011.

(51) Int. Cl. F16K 37/00

(52) U.S. Cl. 137/554

(57) ABSTRACT

Methods and apparatus to determine a position of a valve are disclosed. An example apparatus disclosed herein includes a rotary valve assembly and a visual indicator assembly coupled to the rotary valve assembly to indicate a position of a fluid control member of the rotary valve assembly. The visual indicator assembly includes a follower and a shell surrounding the follower. A position of the follower is to correspond to the position of the fluid control member. The example apparatus further includes an electronic position monitor coupled to the shell to determine valve position information based on the position of the follower.

### RELATED APPLICATION

This patent claims the benefit of U.S. Provisional Patent Application Ser. No. 61/525,265, entitled “Electronic Valve Position Indicating Apparatus and Methods,” which was filed on Aug. 19, 2011, and is incorporated herein by reference in its entirety.

### FIELD OF THE DISCLOSURE

This patent relates generally to valves and, more specifically, to methods and apparatus to determine a position of a valve.

### BACKGROUND

A manually operable valve, such as a butterfly valve, may use a mechanical device to visually indicate a position of a fluid control member in the valve. Generally, the device is operably coupled to the valve, and an operator travels to a location of the valve to visually inspect the device to determine the position of the fluid control member.

### SUMMARY

An example apparatus disclosed herein includes a follower to be rotatably coupled to a rotary valve assembly. A position of the follower is to correspond to a position of a fluid control member of the rotary valve assembly. The example apparatus further includes a shell surrounding the follower and coupled to the rotary valve assembly. A position of the follower relative to the shell is to visually indicate a position of the fluid control member. The example apparatus also includes a magnetic target coupled to the follower to rotate with the follower. An electronic position monitor is coupled to the shell to generate valve position information based on a magnetic field supplied by the magnetic target.

Another example apparatus disclosed herein includes a rotary valve assembly. The example apparatus further includes a visual indicator assembly coupled to the rotary valve assembly to indicate a position of a fluid control member of the rotary valve assembly. The visual indicator assembly includes a follower and a shell surrounding the follower. A position of the follower is to correspond to the position of the fluid control member. The example apparatus further includes an electronic position monitor coupled to the shell to valve position information based on the position of the follower.

Another example apparatus disclosed herein includes a manually operable rotary valve and a visual valve position indicator coupled to the rotary valve to visually indicate a position of a fluid control member of the rotary valve. The example apparatus further includes an electronic position monitor coupled to the visual valve position indicator to generate valve position information and wirelessly communicate the valve position information.

### BRIEF DESCRIPTION OF THE DRAWINGS

FIG. 1 illustrates an example apparatus disclosed herein.

FIG. 2 illustrates an enlarged view of a portion of the example apparatus of FIG. 1

FIG. 3 illustrates an electronic position monitor coupled to an example shell of a visual indicator assembly of the example apparatus of FIG. 1.

FIG. 4 illustrates a magnetic target coupled to an example follower of the example visual indicator assembly.

FIG. 5 is an enlarged view of the electronic position monitor coupled to the visual indicator assembly.

### DETAILED DESCRIPTION

Example apparatus disclosed herein enable an operator to remotely monitor and/or visually monitor a position of a fluid control member in a rotary valve. An example apparatus disclosed herein includes a visual indicator assembly coupled to a rotary valve assembly. In some examples, the visual indicator includes a follower and a shell. A position of the follower is to correspond to a position of a fluid control member of the rotary valve assembly. In some examples, a magnetic target is coupled to the follower. The shell may be coupled to the rotary valve assembly to surround (e.g., cover) the follower. An electronic position monitor is coupled to the shell, and the electronic position monitor is positioned on the shell to enable to the electronic position monitor to sense a magnetic field supplied by the magnetic target.

In operation, the electronic position monitor determines the position of the fluid control member based on the magnetic field supplied by the magnetic target and electronically communicates the position of the fluid control member to a controller, a workstation, and/or any other device or system in a process control environment via hardwiring and/or a wireless transmitter. Thus, the example apparatus enables an operator to remotely monitor and/or visually monitor the position of the fluid control member in the rotary valve assembly.

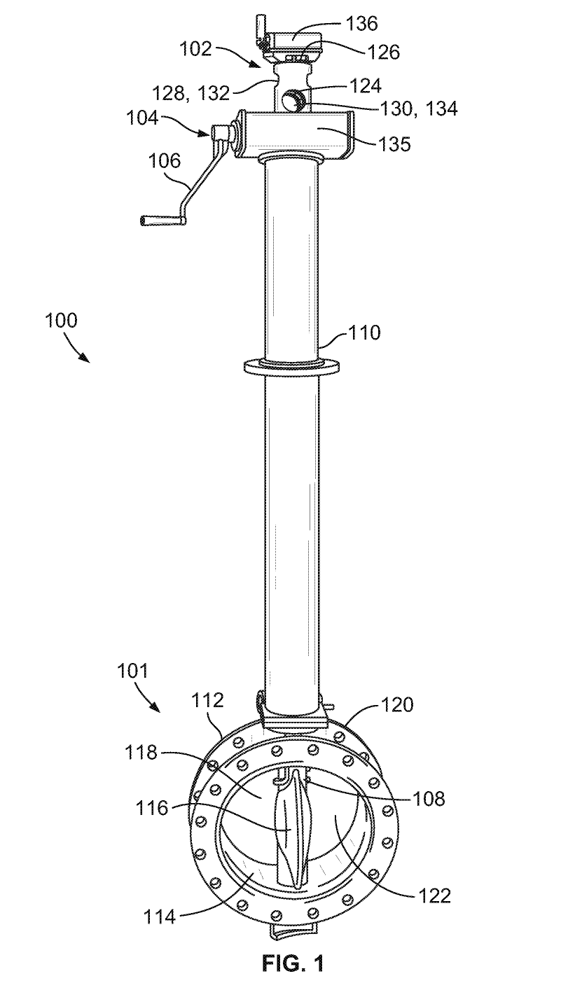

FIG. 1 depicts an example rotary valve assembly 100 disclosed herein. In the illustrated example, the rotary valve assembly 100 includes a butterfly valve 101. In other examples, the rotary valve assembly 100 includes another type of rotary valve (e.g., a ball valve, etc.). A visual indicator assembly 102 is coupled to a manually operable actuator 104 of the rotary valve assembly 100. In the illustrated example, the actuator 104 includes a crank or handle 106 to rotate a valve shaft 108. The example rotary valve assembly 100 of FIG. 1 includes a bonnet 110 coupled to a valve body 112. In the illustrated example, the valve shaft 108 extends through the bonnet 110 to a sealing area 114 of the valve body 112, where the valve shaft 108 is coupled to a fluid control member 116 (e.g., a disk). The valve body 112 defines a fluid flow passageway 118 having an inlet 120 and an outlet 122.

An operator operates the butterfly valve 101 by rotating the handle 106 to cause the actuator 104 to rotate the valve shaft 108 and, thus, the fluid control member 116. The fluid control member 116 may be rotated between a first position (e.g., an open position) to allow fluid to flow through the fluid flow passageway 118 and a second position (e.g., closed position) to restrict or prevent fluid flow through the fluid flow passageway 118.

In the illustrated example, the visual indicator assembly 102 visually indicates a position of the fluid control member 116 in the fluid flow passageway 118. The visual indicator assembly 102 illustrated in FIG. 1 includes a follower 124 and a shell 126. The example follower 124 and the shell 126 each include two pairs of visual indicators 128, 130 and 132, 134, respectively.

More specifically, the example visual indicators 128, 130 and 132, 134 are pairs of opposed openings in the follower 124 and the shell 126. In the illustrated example, the visual indicators, 128, 130 and 132, 134 are opposed openings, where the first pairs of visual indicators 128 and 132 are coaxially aligned along a first axis perpendicular to a longitudinal axis of the follower 124 and the shell 126. The other pairs of visual indicators 130 and 134 are coaxially aligned to a second axis perpendicular to the first axis and perpendicular to the longitudinal axis. Additionally, the first and second axes are spaced apart along the longitudinal axis of the follower 124 and shell 126.

The visual indicators 128, 130 and 132, 134 in the follower 124 and shell 126 are positioned so that when the follower 124 is disposed within the shell 126, the first and second axes of the visual indicators 128, 132 and 130, 134 are disposed on different, offset planes. Thus, rotation of the follower 124 relative to the shell 126 can cause the visual indicators 128, 130 and 132, 134 in the follower 124 and the shell 126 to move into and/or out of coaxial alignment (i.e., such that the openings are coincident). When the visual indicators 128, 130 and 132, 134 of the follower 124 and shell 126 are aligned, two orthogonal visual passages are provided through the follower 124 and shell 126. Conversely, for any rotational position of the follower 124 relative to the shell 126 where the visual indicators 128, 130 and 132, 134 are not aligned (i.e., when the visual indicators 128, 130 and 132, 134 of the follower 124 and shell 126 overlap but are not coincident with each other), the degree of non-alignment is visually detectable as a size (or complete lack thereof) of the visual passage through the follower 124 and shell 126.

The follower 124 is coupled to the valve shaft 108 (e.g., via the actuator 104) and, thus, rotates with the valve shaft 108. Thus, a position of the follower 124 corresponds to a position of the fluid control member 116. In the illustrated example, the shell 126 is fixed to a housing 135 of the actuator 104 and, thus, is fixed relative to the valve shaft 108. As a result, when the valve shaft 108 rotates, the visual indicators 128, 130 and 132, 134 in the follower 124 and the shell 126 may be moved into and out of alignment as noted above for various positions of the valve shaft 108 and the fluid control member 116. In one position, such as a fully open position of the fluid control member 116, the visual indicators 128, 130 and 132, 134 of the follower 124 and the shell 126 are aligned (e.g., coincident), and, thus, the visual indicators 128, 130 and 132, 134 provide two, orthogonal, cylindrically-shaped visual passages through the follower 124 and the shell 126. In another position, such as a fully closed position of the fluid control member 116, the visual indicators 128, 130 and 132, 134 of the follower 124 and shell 126 are sufficiently non-aligned so that the visual indicators 128, 130 and 132, 134 provide no visual passage through the follower 124 and the shell 126. In other positions, such as a position between the fully open and fully closed positions, the visual indicators 128, 130 and 132, 134 of the follower 124 and the shell 126 may overlap to some degree, thereby providing two orthogonal, visual passages through the follower 124 and the shell 126. The size of the visual passages in these positions may vary based on the number of degrees of relative rotation between the follower 124 and the shell 126 to indicate the position of the fluid control member 116 relative to the fully open and fully closed positions of the fluid control member 116. In some examples, to determine a position of the fluid control member 116 of the example rotary valve assembly 100, an operator travels to a location of the rotary valve assembly 100 to visually inspect the visual indicator assembly 102. As described in greater detail below, an electronic position monitor 136 is coupled to the example visual indicator assembly 102 to generate and communicate valve position information.

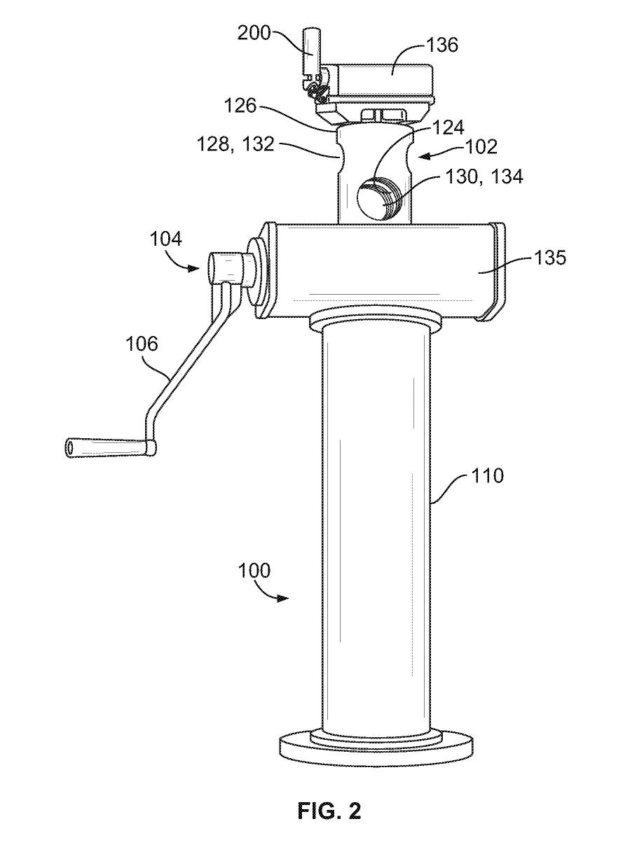

FIG. 2 is an enlarged view of a portion of the example rotary valve assembly 100 of FIG. 1. In the illustrated example, the electronic position monitor 136 is coupled to the visual indicator assembly 102. As described in greater detail below, the electronic position monitor 136 is mounted to the shell 126 of the visual indicator assembly 102 so that the electronic position monitor 136 generates valve position information (e.g., percent open) based on the position of the follower 124. The valve position information may be electronically conveyed (e.g., wirelessly or via wires) to a remotely located operator terminal and/or any other device or system at which the operation of the rotary valve assembly 100 may be monitored. In the illustrated example, the valve position monitor 136 includes a transmitter 200 to wirelessly communicate the valve position information. Thus, a position of the fluid control member 116 of the rotary valve assembly 106 may be monitored remotely, thereby enabling personnel to assess the operation of the rotary valve assembly 100 without requiring time consuming, expensive, and potentially unsafe trips to a location of the rotary valve assembly 100.

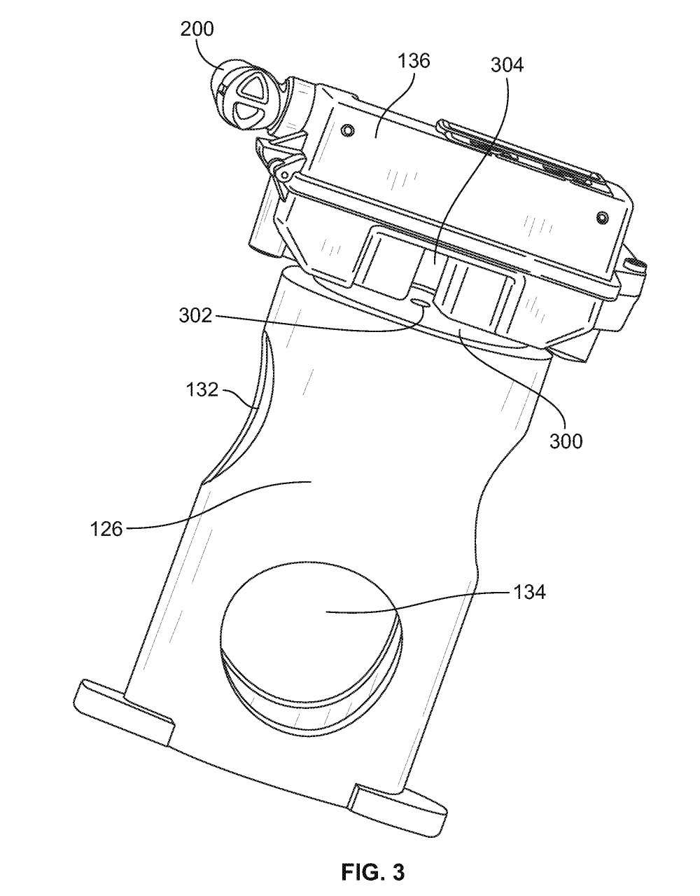

FIG. 3 is an enlarged view of the electronic position monitor 136 coupled to the shell 126 of the example visual indicator assembly 102 of FIG. 2. In the illustrated example, a top surface 300 of the shell 126 defines an opening 302. As illustrated in FIG. 3, the visual indicators 132 and 134 are opposed and coaxially aligned openings that define two, orthogonal visual passages through the follower 124. The example electronic position monitor 136 is coupled to the top surface 300 of the shell 126. The electronic position monitor 136 defines a recess 304 adjacent the top surface 300 of the shell 126. The recess 304 is positioned over the opening 302 in the top surface 300 of the shell 126.

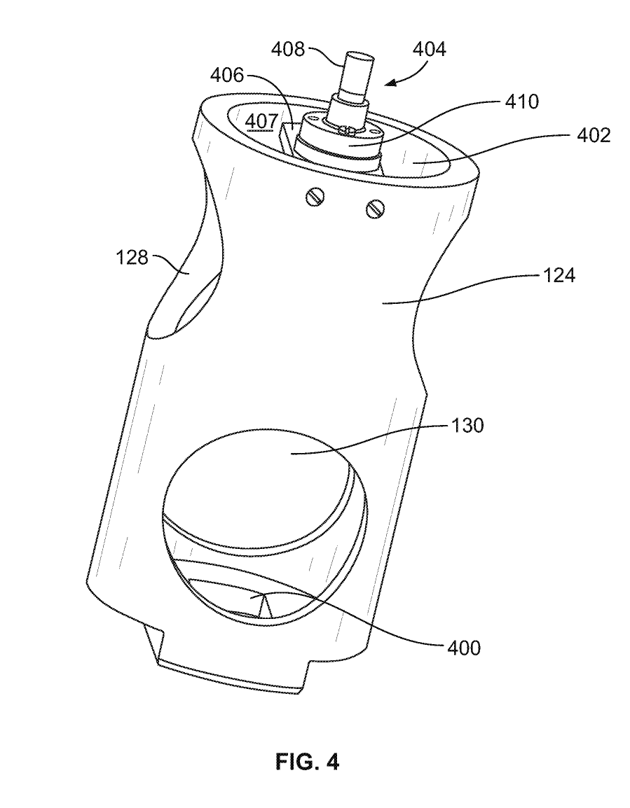

The example electronic position monitor 136 includes one or more sensors capable of detecting magnetic fields in and/or near the recess 304. As described in greater detail below, the recess 304 of the electronic position monitor 136 receives a magnetic target 404 (FIG. 4) coupled to the follower 124, thereby enabling the electronic position monitor 136 to detect the position of the follower 124 and, thus, the fluid control member 116.

FIG. 4 is an enlarged view of the follower 124 of the example visual indicator assembly 102. The example follower 124 of FIG. 4 is substantially cylindrical. Other example followers are other shapes. In the illustrated example, the follower 124 includes an aperture 400 to receive the valve shaft 108. The aperture 400 may be shaped to receive a square-shaped end of the valve shaft 108 (i.e., the follower 124 may be keyed to the valve shaft 108) so that the follower 124 rotates with the valve shaft 108. In the illustrated example, the follower 124 includes a bore 402 that is coaxially aligned with the valve shaft 108. As illustrated in FIG. 4, the two pairs of visual indicators 128 and 130, which are opposed and coaxially aligned openings, define two, orthogonal visual passages through the follower 124.

In the illustrated example, the follower 124 includes the magnetic target 404. The magnetic target 404 is coupled to the follower 124 via a beam-shaped support 406 that bridges across the bore 402 of the follower 124. More specifically, the beam-shaped support 406 is coupled to an upper portion of interior walls 407 of the bore 402 on a first axis perpendicular to the longitudinal axis of the follower 124. The example magnetic target 404 of FIG. 4 includes a magnetic stem 408 extending from a base 410. The example base 410 of FIG. 4 is cylindrically-shaped and coupled to the beam-shaped support 406. In other examples, the base 410 may be mounted directly to the follower 124 and/or to any other suitable support coupled to the follower 124. The magnetic stem 408 extends from the base 410 on an axis perpendicular to the first axis. In the illustrated example, the valve shaft 108, the bore 402, the base 410, and the magnetic stem 408 are coaxially aligned along the longitudinal axis of the follower 124. As described in greater detail below, the electronic position monitor 136 generates valve position information based on a magnetic field supplied by the magnetic stem 408.

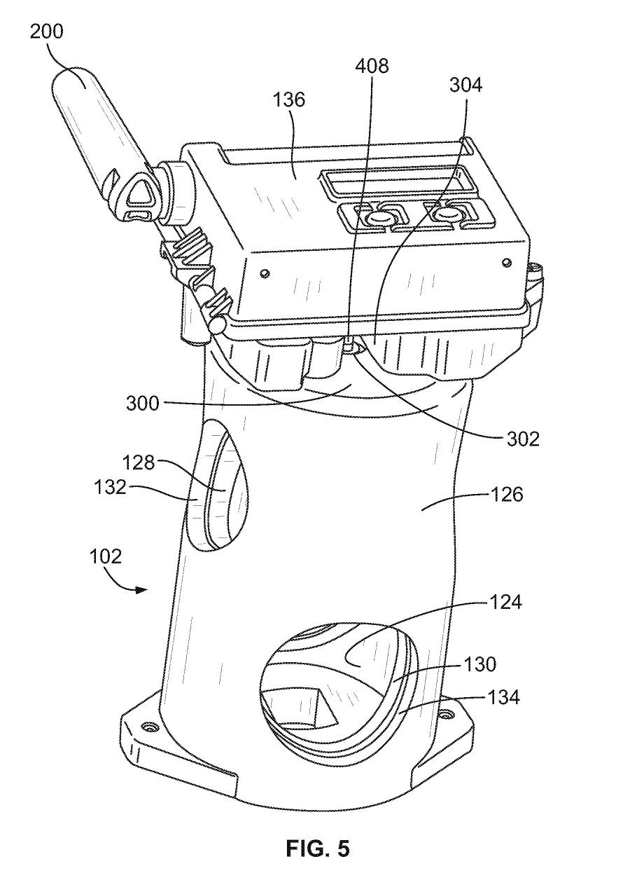

FIG. 5 illustrates the electronic position monitor 136 and the visual indicator assembly 102. In the illustrated example, the shell 126 covers the follower 124 so that the magnetic stem 408 of the magnetic target 404 extends through the opening 302 in the top surface 300 of the shell 126, thereby enabling the electronic position monitor 136 to receive the magnetic stem 408 within the recess 304 of the electronic position monitor 136. The magnetic stem 408 supplies a magnetic field, which is detected by the one or more sensors in the electronic position monitor 136. Based on the magnetic field detected by the one or more sensors in the electronic position monitor 136, the electronic position monitor 136 generates valve position information that can be wirelessly communicated via the transmitter 200 to an operator terminal and/or any other device or system at which the operation of the example rotary valve assembly 100 may be monitored.

Although certain example methods, apparatus and articles of manufacture have been described herein, the scope of coverage of this disclosure is not limited thereto. On the contrary, this disclosure covers all methods, apparatus and articles of manufacture fairly falling within the scope of the claims.

The Abstract at the end of this disclosure is provided to comply with 37 C.F.R. §1.72(b) to allow the reader to quickly ascertain the nature of the technical disclosure. It is submitted with the understanding that it will not be used to interpret or limit the scope or meaning of the claims.

What is claimed is:

1. An apparatus, comprising:
a follower to be rotatably coupled to a rotary valve assembly, wherein a position of the follower is to correspond to a position of a fluid control member of the rotary valve assembly;
a shell surrounding the follower and to be coupled to the rotary valve assembly, wherein a position of the follower relative to the shell is to visually indicate a position of the fluid control member;
a magnetic target coupled to the follower to rotate with the follower; and
an electronic position monitor coupled to the shell to generate valve position information based on a magnetic field supplied by the magnetic target.

2. The apparatus of claim 1, wherein the electronic position monitor comprises a transmitter to wirelessly communicate the valve position information.

3. The apparatus of claim 1, wherein the shell comprises a first opening through which the follower is to be visible and the follower comprises a second opening, wherein the first opening and the second opening are to move into and out of alignment to visually indicate the position of the fluid control member.

4. The apparatus of claim 1, wherein the rotary valve assembly comprises a manually operable actuator.

5. The apparatus of claim 1, wherein the magnetic target is coupled to the follower along an axis of rotation of the follower.

6. The apparatus of claim 1, wherein the shell defines an aperture through which the magnetic target extends.

7. An apparatus, comprising:
a rotary valve assembly;
a visual indicator assembly coupled to the rotary valve assembly to indicate a position of a fluid control member of the rotary valve assembly, the visual indicator assembly including a follower and a shell surrounding the follower, a position of the follower to correspond to the position of the fluid control member; and
an electronic position monitor coupled to the shell to determine valve position information based on the position of the follower.

8. The apparatus of claim 7, wherein the electronic position monitor comprises a transmitter to wirelessly communicate the valve position information.

9. The apparatus of claim 7 further comprising a magnetic target coupled to the follower, wherein the electronic position monitor is to determine the position of the follower based on a magnetic field supplied by the magnetic target.

10. The apparatus of claim 9, wherein the magnetic target is coupled to the follower along an axis of rotation of the follower.

11. The apparatus of claim 9, wherein the shell defines an aperture through which the magnetic target extends.

12. The apparatus of claim 7, wherein the shell defines a first opening and a second opening though which the follower is to be visible, the first opening orthogonal to the second opening.

13. The apparatus of claim 12, wherein the follower defines a third opening and a fourth opening, the third opening orthogonal to the fourth opening, wherein the third opening and the fourth opening are to move into and out of coaxial alignment with the first opening and the second opening, respectively, to indicate the position of the fluid control member.

14. The apparatus of claim 7, wherein the visual indicator assembly is coupled to a manually operable actuator of the rotary valve assembly.

15. An apparatus, comprising:
a manually operable rotary valve;
a visual valve position indicator coupled to the rotary valve to visually indicate a position of a fluid control member of the rotary valve; and
an electronic position monitor coupled to the visual valve position indicator to generate valve position information and wirelessly communicate the valve position information.

16. The apparatus of claim 15, wherein the visual valve position indicator comprises a follower and a shell surrounding the follower, a position of the follower to correspond to the position of the fluid control member.

17. The apparatus of claim 16, wherein the shell comprises a first opening through which the follower is to be visible and the follower comprises a second opening, wherein the first opening and the second opening are to move into and out of alignment to visually indicate the position of the fluid control member.

18. The apparatus of claim 15, further comprising a magnetic target coupled to the follower, wherein the electronic position monitor is to generate the valve position information based on a magnetic field supplied by magnetic target.

19. The apparatus of claim 18, wherein the magnetic target is coupled to the follower along an axis of rotation of the follower.

20. The apparatus of claim 15, wherein the visual valve position indicator is coupled to a manually operable actuator of the rotary valve.
